(19) United States
(12) Patent Application Publication
(10) Pub. No.: US 2013/0244698 A1
(43) Pub. Date: Sep. 19, 2013

(54) INFORMATION PROCESSING APPARATUS, NON-TRANSITORY COMPUTER READABLE MEDIUM THAT STORES PROGRAM, AND INFORMATION PROCESSING METHOD

(71) Applicants: Kago TAI, Kanagawa (JP); Kensaku HONDA, Kanagawa (JP)

(72) Inventors: Kago TAI, Kanagawa (JP); Kensaku HONDA, Kanagawa (JP)

(73) Assignee: FUJI XEROX CO., LTD., Tokyo (JP)

(21) Appl. No.: 13/618,420

(22) Filed: Sep. 14, 2012

(30) Foreign Application Priority Data
Mar. 16, 2012 (JP) 2012-060553

(51) Int. Cl. H04W 4/02

(52) U.S. Cl. CPC H04W 4/025
USPC 455/456.3

(57) ABSTRACT

An information processing apparatus includes a controller that performs a control for storing, in a case where an instruction for storage of management target information is performed, the management target information and for matching, for storage in a storage area, region information indicating a predetermined range of regions that includes a place where the instruction is performed with storage location information indicating a storage location where the management target information is stored, a receiving unit that receives specified place information indicating a specified place, and a presentation unit that presents, in a case where region information corresponding to the specified place information received by the receiving unit is stored in the storage area, the storage location information matched with the region information corresponding to the specified place information.

### CROSS-REFERENCE TO RELATED APPLICATIONS

This application is based on and claims priority under 35 USC 119 from Japanese Patent Application No. 2012-060553 filed Mar. 16, 2012.

### BACKGROUND

### Technical Field

The present invention relates to an information processing apparatus, a non-transitory computer readable medium that stores a program, and an information processing method.

### SUMMARY

According to an aspect of the invention, there is provided an information processing apparatus including: a controller that performs a control for storing, in a case where an instruction for storage of management target information is performed, the management target information and for matching, for storage in a storage area, region information indicating a predetermined range of regions that includes a place where the instruction is performed with storage location information indicating a storage location where the management target information is stored; a receiving unit that receives specified place information indicating a specified place; and a presentation unit that presents, in a case where region information corresponding to the specified place information received by the receiving unit is stored in the storage area, the storage location information matched with the region information corresponding to the specified place information.

### BRIEF DESCRIPTION OF THE DRAWINGS

Exemplary embodiments of the present invention will be described in detail based on the following figures, wherein:

FIG. 1 is a block diagram illustrating an example of functions of the main sections of an information processing system according to an exemplary embodiment;

FIG. 2 is a block diagram illustrating an example of a configuration of the main sections of an electric system of a server apparatus included in an information processing system according to an exemplary embodiment;

FIG. 3 is a block diagram illustrating an example of a configuration of the main sections of an electric system of a communication device included in an information processing system according to an exemplary embodiment;

FIG. 4 is a diagram schematically illustrating a configuration example of an attribute DB included in a server apparatus according to an exemplary embodiment;

FIG. 5 is a diagram schematically illustrating a configuration example of a user DB included in a server apparatus according to an exemplary embodiment;

FIG. 6 is a diagram schematically illustrating a configuration example of a place DB included in a server apparatus according to an exemplary embodiment;

FIG. 7 is a flowchart illustrating an example of the flow of a matching process according to an exemplary embodiment;

FIG. 8 is a flowchart illustrating an example of the flow of a search request process according to an exemplary embodiment;

FIG. 9 is a diagram illustrating an example of a search target designation screen displayed in a display of a communication device according to an exemplary embodiment;

FIG. 10 is a diagram illustrating an example of an arrangement order designation screen displayed in a display of a communication device according to an exemplary embodiment;

FIG. 11 is a flowchart illustrating an example of the flow of a presentation process according to an exemplary embodiment; and

FIG. 12 is a flowchart subsequent to the flowchart shown in FIG. 11.

### DETAILED DESCRIPTION

Hereinafter, an example of an exemplary embodiment of a disclosed technique will be described in detail with respect to the accompanying drawings. In the following description, as an example of an information processing system, an information processing system including a tablet type mobile terminal with a global positioning system (GPS) function and a server apparatus is used. Here, as an example of the “server apparatus”, a server apparatus that provides service according to a request from the mobile terminal is used. The mobile terminal is not limited to the tablet type, and for example, may be a multifunctional mobile phone (a so-called smart phone), a portable personal computer, or the like.

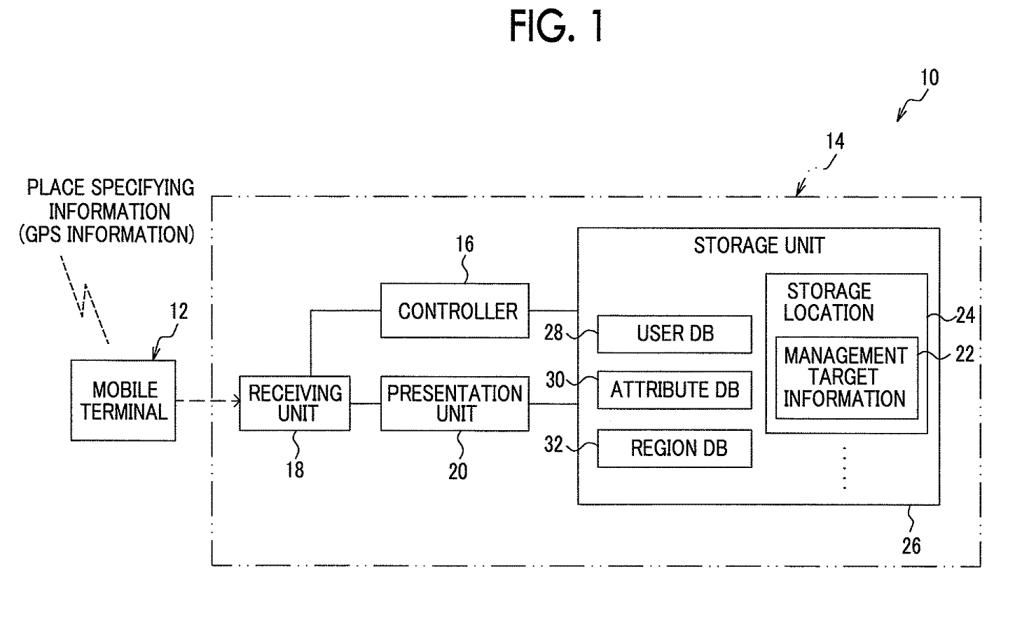

FIG. 1 shows an example of functions of the main sections of an information processing system 10 according to an exemplary embodiment of the invention. The information processing system 10 includes a mobile terminal 12 and a server apparatus 14 that is an example of an information processing apparatus. The server apparatus 14 includes a controller 16, a receiving unit 18, and a presentation unit 20.

In a case where an instruction for storage of management target information 22 is given, the controller 16 performs a control for storing the management target information 22 in a storage location 24. The management target information 22 represents target information managed by the server apparatus 14, for example, and if it is information stored in a storage area of the server apparatus 14, any information may be used as the management target information 22. The storage location 24 represents a folder that stores data, for example, but is not limited thereto, and may be a directory, or may be a storage area used for classification or storage of data.

Further, the controller 16 performs a control so that region information indicating a predetermined range of regions that includes a place where the instruction for storage of the management target information 22 is given and storage location information indicating the storage location 24 that stores the management target information 22 are stored in a user DB (database) 28 of a storage unit 26 and an attribute DB 30 to be matched with each other. In the present exemplary embodiment, as an example of the “predetermined range of regions that includes the place where the instruction for storage of the management target information 22 is given”, a range of division regions obtained by dividing a map indicating a predetermined region in a mesh form is used. Further, the user DB 28 refers to a DB that manages storage location information in the unit of users (details thereof will be described later). Further, the attribute DB 30 refers to a DB in which attributes relating to the storage location 24 and the storage location information are matched with each other. Further, a place DB 32 in which the region information and latitude and longitude information, corresponding to GPS information are matched with each other, is stored in the storage unit 26. Here, the “information corresponding to GPS information” represents information indicating latitude, longitude, height and the like, for example.

The receiving unit 18 receives specified place information indicating a specified place. Here, the “specified place” represents a place where the mobile terminal 12 is currently present, and indicates a place specified by operation of a GPS function in the mobile terminal 12. Further, in the present exemplary embodiment, a configuration is used in which the specified place information is received by receiving the specified place information transmitted from the mobile terminal 12 in the place where the instruction for storage of the management target information 22 is given. Further, the receiving unit 18 again receives the instruction for storage of the management target information 22, the region information and the management target information 22, and the controller 16 performs a control on the basis of the reception result of the receiving unit 18. That is, the controller 16 stores the management target information 22 received by the receiving unit 18 in the storage location 24. Further, the controller 16 performs a control so that the region information received by the receiving unit 18 and the storage location information indicating the storage location 24 that stores the management target information 22 received by the receiving unit 18 are stored in the storage unit 26 to be matched with each other.

In the present exemplary embodiment, GPS information is employed as an example of the “specified place information”. The GPS information represents information indicating longitude, latitude, height and the like for specifying a current position calculated with errors of several centimeters to several tens of meters as radio waves are received from plural GPS satellites. Hereinafter, in order to prevent confusion, the GPS information will be described as an example of the specified place information.

In a case where the region information corresponding to the specified place information received by the receiving unit 18 is stored in the storage unit 26, the presentation unit 20 presents storage location information matched with the region information corresponding to the specified place information. For example, since the region information and the latitude and longitude information are matched with each other in the region DB 32, the presentation unit 20 acquires region information matched with latitude and longitude information corresponding to the GPS information received by the receiving unit 18. Further, the presentation unit 20 searches the storage location information matched with the acquired region information from the storage unit 26, and transmits the search result to the mobile terminal 12 to present the storage location information. For example, the presentation unit 20 presents the storage location information to a user through the mobile terminal 12. That is, the mobile terminal 12 receives the storage location information transmitted from the server apparatus 14, and displays the storage location indicated by the received storage location information on a display device (for example, a display) to present the storage location information to the user.

Further, the receiving unit 18 further receives user specifying information for specifying a user that gives an instruction for storage of the management target information 22. In the present exemplary embodiment, for example, the receiving unit 18 performs reception by receiving the user specifying information transmitted from the mobile terminal 12, for example. That is, in a case where the user instructs the server apparatus 14 to store the management target information 22 in the storage location 24 through the mobile terminal 12, the mobile terminal 12 transmits the user specifying information for specifying the user that gives the instruction for storage of the management target information 22 in the storage location 24. Here, as an example of the “user specifying information”, for example, login information (so-called login name or ID) used in login to the mobile terminal 12 is used. Further, information for specifying an individual who is stored in advance in the mobile terminal 12 may be used.

In the present exemplary embodiment, the mobile terminal 12 and the server apparatus 14 perform an exchange of information, for example, by wireless communication. Accordingly, the receiving unit 18 according to the present exemplary embodiment receives the user specifying information transmitted from the mobile terminal 12 to receive the user specifying information. In this way, by receiving the user specifying information with the receiving unit 18, the presentation unit 20 performs narrowing-down of the storage location information that is a presentation target, using the received user specifying information. That is, the presentation unit 20 searches the storage location information matched with the user specified by the user specifying information received by the receiving unit 18 from the user DB 28. Further, the presentation unit 20 acquires the storage location information matched with the region information corresponding to the specified place information received by the receiving unit 18 from the searched and obtained storage location information, and presents the acquired storage location information to the user.

Further, the receiving unit 18 further receives attribute specifying information for specifying an attribute assigned to the user that gives the instruction for storage of the management target information 22. In the present exemplary embodiment, the receiving unit 18 performs reception by receiving the attribute specifying information transmitted from the mobile terminal 12, for example. That is, in a case where the user instructs the server apparatus 14 to store the management target information 22 in the storage location 24 through the mobile terminal 12, the mobile terminal 12 transmits the attribute specifying information for specifying the attribute of the user that gives the instruction. The receiving unit 18 receives the attribute specifying information by receiving the attribute specifying information transmitted from the mobile terminal 12. In this way, since the attribute specifying information is received by the receiving unit 18, the presentation unit 20 performs narrowing-down of the storage location information that is the presentation target, using the received attribute specifying information. That is, the presentation unit 20 searches the storage location information matched with the attribute specified by the attribute specifying information received by the receiving unit 18 from the user DB 28. Further, the presentation unit 20 acquires the storage location information matched with the region information corresponding to the specified place information received by the receiving unit 18 from the searched and obtained storage location information, and presents the acquired storage location 24 to the user.

Further, the receiving unit 18 receives period specifying information for specifying a period during which the management target information 22 is stored in the storage location 24. In the present exemplary embodiment, for example, the receiving unit 18 receives the period specifying information transmitted from the mobile terminal 12. That is, when the user gives the instruction for storage of the management target information 22 in the storage location 24 to the server apparatus 14 through mobile terminal 12, the mobile terminal 12 transmits the period specifying information. The receiving unit 18 receives the period specifying information by receiving the period specifying information transmitted from the mobile terminal 12. In this way, since the period specifying information is received by the receiving unit 18, the presentation unit 20 performs narrowing down of the storage location information that is the presentation target, using the received period specifying information. That is, the presentation unit 20 searches the storage location information indicating the storage location 24 in which the management target information 22 is stored at the period specified by the period specifying information received by the receiving unit 18 from the attribute DE 30. Further, the presentation unit 20 acquires the storage location information matched with the region information corresponding to the place specifying information received by the receiving unit 18 from the searched and obtained storage location information, and presents the acquired storage location information to the user.

Further, in a case where the instruction for storage of the management target information 22 is given, the controller 16 performs a control so that the region information indicating the predetermined range of regions that includes the place where the instruction is given is again matched with the storage location information indicating the storage location 24 where the management target information 22 is stored according to the instruction for storage of the management target information 22, to be stored in the storage unit 26. The disclosed technique is not limited thereto, and for example, in a case where the instruction for storage of the management target information 22 is given, the controller 16 may perform a control so that the region information indicating the predetermined range of regions including the place where the instruction is given is replaced with region information that is currently matched with the storage location information indicating the storage location 24 where the management target information 22 is stored according to the instruction for storage of the management target information 22 to be stored (written) in the storage unit 26.

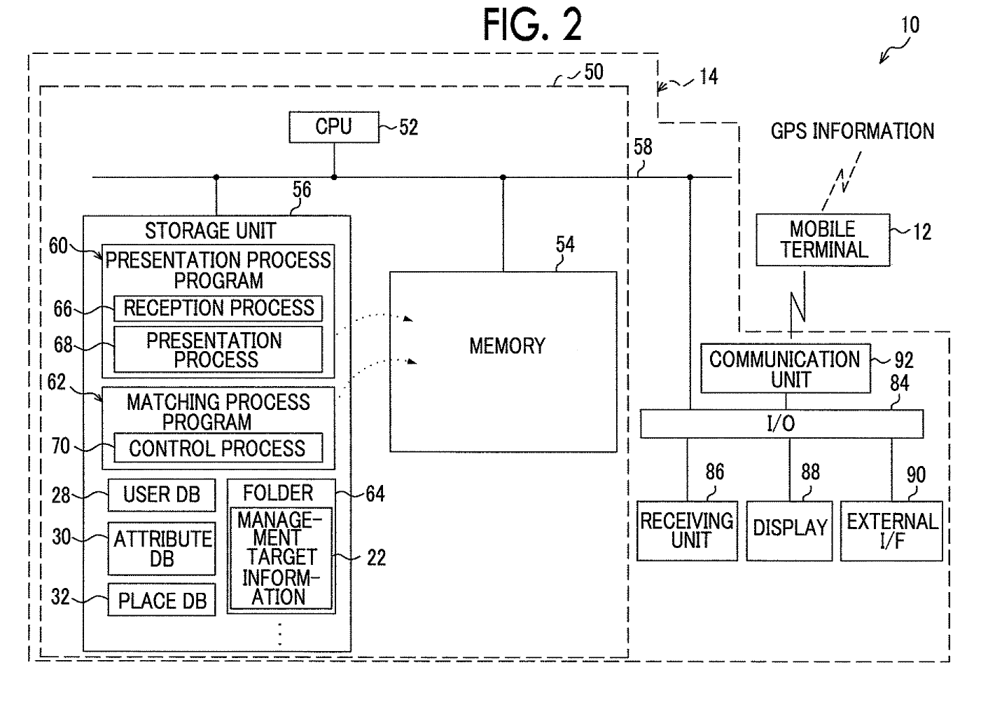

The controller 16, the receiving unit 18 and the presentation unit 20 are realized by a computer 50 that is built in the server apparatus 14, shown in FIG. 2 and another input and output device, for example. FIG. 2 shows a configuration example of main parts of an electric system of the server apparatus 14. As shown in FIG. 2, the computer 50 includes a Central Processing Unit (CPU) 52, a memory 54 and a non-volatile storage unit 56. These components are connected with each other through a bus 58 that includes an address bus, a system bus and the like. The storage unit 56 may be realized by a Hard Disk Drive (HDD), a flash memory, or the like. In the storage unit 56 that is a recording medium, a presentation process program 60, a matching process program 62, a folder 64 that is an example of the storage location 24, the user DB 28, the attribute DB 30 and the region DB 32 are stored. The CPU 52 reads the presentation process program 60 from the storage unit 56 to develop the read presentation process program 60 to the memory 54, and sequentially performs processes included in the presentation process program 60. The presentation process program 60 includes a reception process 66 and a presentation process 68. The CPU 52 executes the reception process 66 to operate as the receiving unit 18 shown in FIG. 1. The CPU 52 executes the presentation process 68 to operate as the presentation unit 20 shown in FIG. 1.

Further, the CPU 52 reads the matching process program 62 from the storage unit 56 to develop the read matching process program 62 to the memory 54, and sequentially performs processes included in the matching process program 62. The matching process program 62 includes a control process 70. The CPU 52 executes the control process 70 to operate as the controller 16 shown in FIG. 1.

In this way, in a case where the controller 16, the receiving unit 18 and the presentation unit 20 are realized by the computer 50, the storage unit 56 that stores the user DB 28, the attribute DB 30, the region DB 32 and the folder 64 is used as the storage unit 26 shown in FIG. 1.

Here, an example in which the presentation process program 60 and the matching process program 62 are read from the storage unit 56 is shown, but it is not necessary to store the presentation process program 60 and the matching process program 62 in the storage unit 56 from the beginning. For example, each program may be firstly stored in an arbitrary “portable storage medium” such as a flexible disk, that is, an FD, a CD-ROM, a DVD, a magneto-optical disc or an IC card that is connected for use to the computer 50. Then, the computer 50 may acquire each program from the portable storage medium for execution. Further, each program may be stored in a different computer or server apparatus connected to the computer 50 through the internet, a Local Area Network (LAN) or the like, and the computer 50 may then acquire each program from the different computer or server apparatus for execution.

The server apparatus 14 includes an input and output interface (I/O) 84 that electrically connects the computer 50 to various input and output devices to perform transmission and reception of various information between the computer 50 and the various input and output devices. In the present exemplary embodiment, as input and output devices that are connected to the I/O 84 and are electrically connected to the computer 50 through the bus 58, a receiving unit 86, a display 88, an external interface (I/F) 90 and a communication unit 92 are provided.

The receiving unit 86 receives an operation input from a user of the server apparatus 14. As the receiving unit 86, for example, an input device such as a key board, a mouse, a transmissive touch panel overlapped for use on a display, an operation button for power input, an operation button for setting various information and a scroll key is used.

The display 88 displays various information. A liquid crystal display is used as the display 88, for example. In the present exemplary embodiment, a touch panel display that is formed by overlapping a touch panel that is a part of the receiving unit 86 with a liquid crystal display that is the display 88 is used.

The communication unit 92 is connected to a communication network such as the internet or LAN, and performs transmission and reception of various information between the mobile terminal 12 connected to the communication network and the computer 50. In the present exemplary embodiment, the communication unit 92 receives storage instruction information indicating an instruction for storage of the management target information 22, folder designation information for designating a folder 64 that stores the management target information 22, GPS information, user specifying information, attribute specifying information and period specifying information from the mobile terminal 12 connected to the communication network.

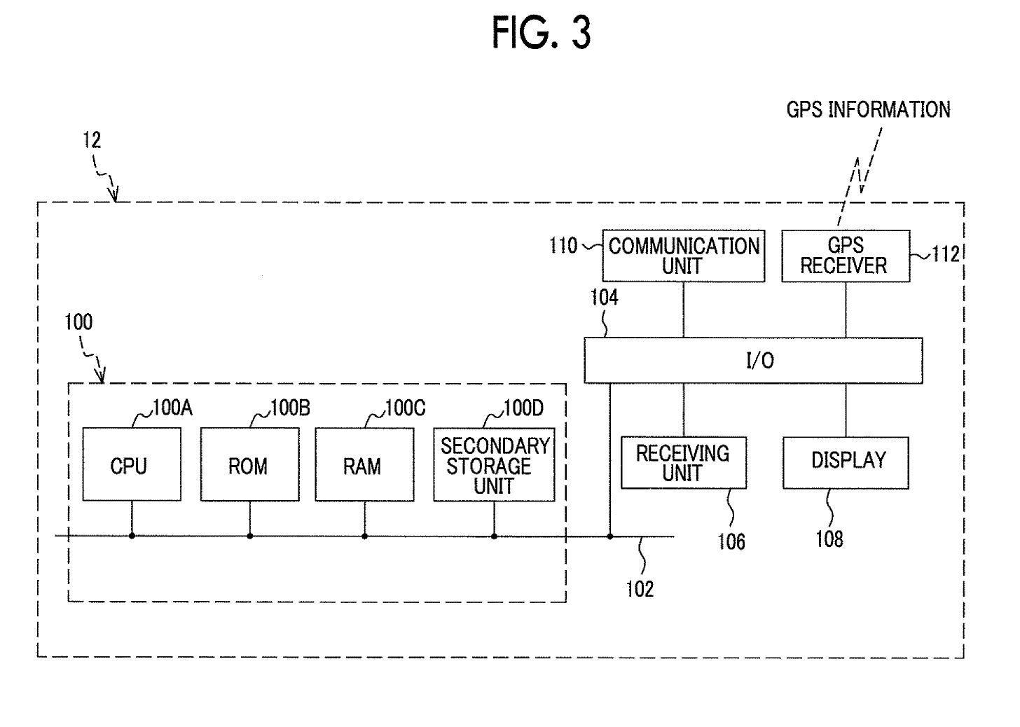

FIG. 3 shows an example of a configuration of the main sections of an electric system of the communication device 12. As shown in FIG. 3, the mobile terminal 12 includes a computer 100. The computer 100 includes a CPU 100A, a Read Only Memory (ROM) 100B, a Random Access Memory (RAM) 100C and a secondary storage unit (for example, flash memory) 100D. The CPU 100A performs an overall operation of the mobile terminal 12. The ROM 100E functions as a memory that stores in advance a control program for controlling a basic operation of the mobile terminal 12, a search request processing program performed by the CPU 100A in order to realize a search request process (which will be described later), various parameters and the like. The RAM 100C is used as a work area or the like when the various programs are executed. The secondary storage unit 100D functions as a non-volatile memory that stores various information that should be stored even though a power switch is turned off. The CPU 100A, the ROM 100B, the RAM 1000 and the secondary storage unit 100D are connected to each other through a bus 102 that includes an address bus, a system bus and the like. Accordingly, information reading from the CPU 100A, the ROM 100B, the RAM 100C and the secondary storage unit 100D and information writing to the RAM 100C and the secondary storage unit 100D are performed, respectively.

The mobile terminal 12 includes an I/O 104 that electrically connects the computer 100 to various input and output devices and performs transmission and reception of various information between the computer 100 and the various input and output devices. In the present exemplary embodiment by connecting to the I/O 104, as input and output devices that are electrically connected to the computer 100 through the bus 102, a receiving unit 106, a display 108 and an external I/F 110 and a GPS receiver 112 are provided.

The receiving unit 106 receives an operation input from a user of the mobile terminal 12 or a dealer that performs maintenance and inspection of the mobile terminal 12, for example. As the receiving unit 106, for example, an input device such as a transmissive touch panel that is overlapped for use with a display, an operation button for power input, an operation button for setting various information or a scroll key is used.

The display 108 displays various information. For example, the display 108 displays a screen used when user specifying information, storage instruction information, folder designation information, attribute specifying information, and period specifying information are received. A liquid crystal display is used as the display 108, for example. In the present exemplary embodiment, a touch panel display that is formed by overlapping a touch panel that is a part of the receiving unit 106 with a liquid crystal display that is the display 108 is used.

The external I/F 110 is connected to a communication network such as the internet or LAN, for example, and performs transmission and reception of various information between the server apparatus 14 connected to the communication network and the computer 100. The GPS receiver 112 receives radio waves from plural GPS satellites and outputs reception result information indicating a reception result to the computer 100. Accordingly, the computer 100 executes a program that is determined in advance on the basis of the reception result information input from the GPS receiver 112 to calculate a current position of the mobile terminal 12 as GPS information.

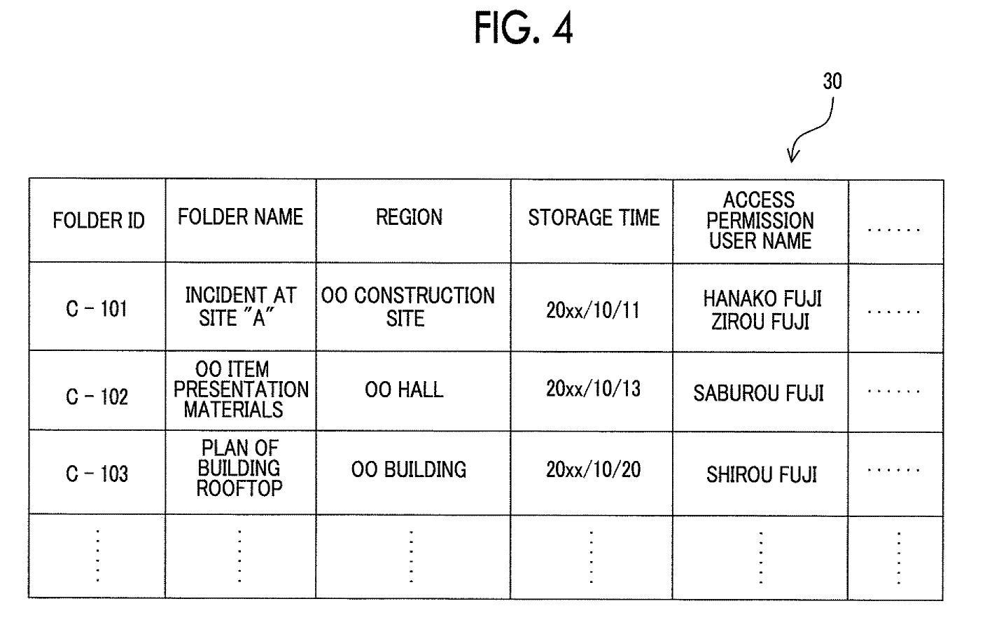

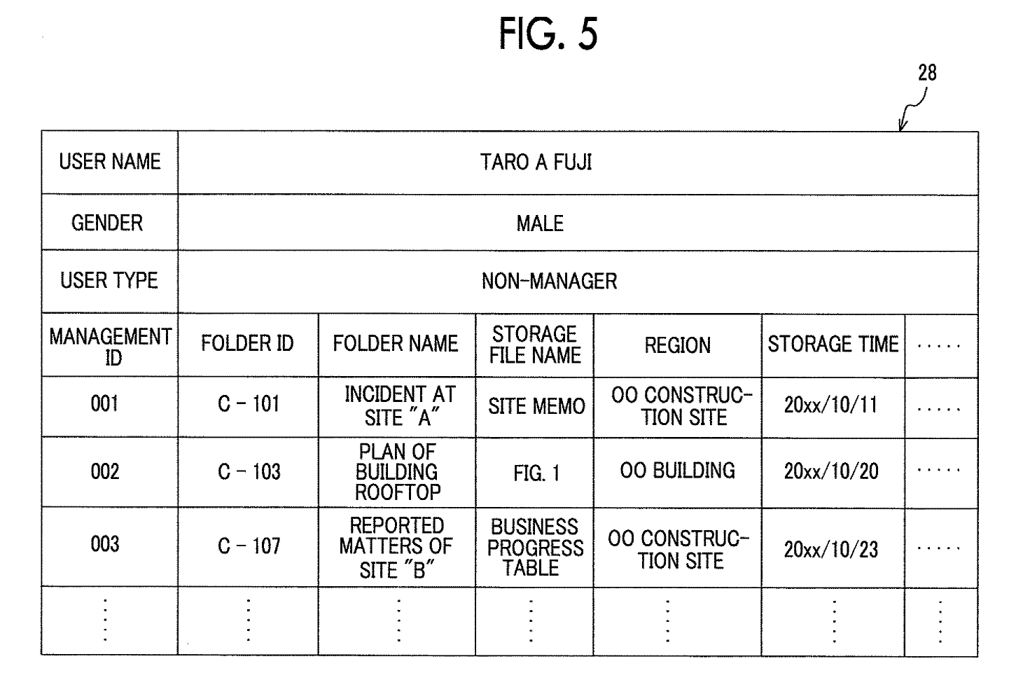

FIG. 4 shows an example of the attribute DB 30. The attribute DB 30 includes various information indicating an attribute relating to each folder 64, according to the folder 64. In the example shown in FIG. 4, a folder ID, folder name information, region information, storage time information and access right permission information are used as examples of information included in the attribute DB 30. The folder ID represents an ID uniquely specifying the folder 64. In the example shown in FIG. 4, “C-101”, “C-102” and “C-103” are shown. The folder name information represents information indicating a title (folder name) given to the folder 64 specified by the folder ID. In the example shown in FIG. 4, folder name information indicating a title of “incident at site A” is allocated to the folder ID “C-101”. Further, in the example shown in FIG. 4, folder name information indicating a title of “OO item presentation materials” is allocated to the folder ID “C-102”. Further, in the example shown in FIG. 4, folder name information indicating a title of “plan of building rooftop” is allocated to the folder ID “C-103”.

Further, in the example shown in FIG. 4, as an example of the region information, region information indicating a division region on a map of “OO construction site” is allocated to the folder ID “C-101”. Further, in the example shown in FIG. 4, as an example of the region information, region information indicating a division region on a map of “OO hall” is allocated to the folder ID “C-102”. Further, in the example shown in FIG. 4, as an example of the region information, region information indicating a division region on a map of “OO building” is allocated to the folder ID “C-103”.

The storage time information represents information about the time (for example, date) when the management target information 22 is stored in the folder 64. In the example shown in FIG. 4, storage time information indicating “20xx/10/11” indicating Oct. 11, 20xx is allocated to the folder ID “C-101”. This means that the management target information 22 is stored in the folder 64 specified by the folder ID “C-101” on Oct. 11, 20xx. Further, in the example shown in FIG. 4, storage time information indicating “20xx/ 10/13” indicating Oct. 13, 20xx is allocated to the folder ID “C-102”. This means that the management target information 22 is stored in the folder 64 specified by the folder ID “C-102” on Oct. 13, 20xx. Further, in the example shown in FIG. 4, storage time information indicating “20xx/ 10/20” indicating Oct. 20, 20xx is allocated to the folder ID “C-103”. This means that the management target information 22 is stored in the folder 64 specified by the folder ID “C-103” on Oct. 20, 20xx.

The access right permission information represents information indicating a user or a group allowed to access the folder 64. In the example shown in FIG. 4, Hanako Fuji and Zirou Fuji are allowed to access a folder indicated by the folder ID “C-101”, Saburou Fuji is allowed to access a folder indicated by the folder ID “C-102”, and Shirou Fuji is allowed to access a folder indicated by the folder ID “C-103”. In a case where each user ID is allocated to each user, the user ID may be registered instead of the user name, and the user name may be specified from the user ID. Further, in a case where access is allowed to all the members of the group to which plural users belong, the group name may be registered instead of the user name, and access may be allowed to all the members of the group.

FIG. 5 shows an example of the user DB 28. The user DB 28 includes various information indicating an attribute relating to the folder 64 in which each user stores the management target information 22, according to the user who stores the management target information 22 in the folder 64. In the example shown in FIG. 5, as an example of the information included in the user DB 28, user name information, gender information, user type information, a management ID, a folder ID, folder name information, a storage file name, region information and storage time information are used. The user name information represents information indicating a name or title that specifies a user who stores the management target information 22 in the folder 64. In the example shown in FIG. 5, user name information indicating a name of “Taro A Fuji” is shown. The gender information represents information indicating the gender of the user specified by the user name information. In the example shown in FIG. 5, gender information indicating “male” is shown. The user type information represents information indicating an attribute given to the user specified by the user name information. In the example shown in FIG. 5, user type information indicating “non-manager” who is not the manager of the server apparatus 14 is shown. Further, a group name to which the user belongs, or the like may be included.

The management ID is an ID that uniquely specifies the history that the user specified by the user name information stores the management target information 22 in the folder 64. That is, the management ID is generated whenever the user stores the management target information 22 in the folder 64. In the example shown in FIG. 5, “001” to “003” are shown as the management ID. Further, the above-mentioned folder ID, the folder name information, the region information and the storage time information are allocated to each management ID. Further, in the example shown in FIG. 5, with respect to the management ID “001”, a folder ID “C-101”, folder name information indicating a title of “incident at site A”, region information indicating a division region on a map of “OO construction site”, and storage time information indicating storage time “20xx/ 10/11” are allocated. Further, with respect to the management ID “002”, a folder ID “C-103” folder name information indicating a title of “plan of building rooftop”, region information indicating a division region on a map of “OO building”, and storage time information indicating storage time “20xx/ 10/20” are allocated. Further, with respect to the management ID “003”, a folder ID “C-107”, folder name information indicating a title of “reported matters at site B”, and region information indicating a division region (a division region that is different from the division region shown by the region information allocated to the management ID “001”) on a map of “OO construction site”, and storage time information indicating storage time “20xx/ 10/23” are allocated.

Further, the storage file name information represents information indicating a title (for example, folder name) that specifies an electronic file that is an example of the management target information 22 stored in the folder 64 specified by the management ID. In the example shown in FIG. 5, storage file name information indicating a title that specifies an electronic file “site memo” is allocated to the management ID “001”. That is, this means that the electronic file to which the title “site memo” is given is stored in the folder 64 specified by the management ID “001”. Further, storage filename information indicating a title that specifies an electronic file “FIG. 1” is allocated to the management ID “002”. That is, this means that the electronic file to which the title “FIG. 1” is given is stored in the folder 64 specified by the management ID “002”. Further, storage file name information indicating a title that specifies an electronic file “business progress table” is allocated to the management ID “003”. That is, this means that the electronic file to which the title “business progress table” is given is stored in the folder 64 specified by the management ID “003”.

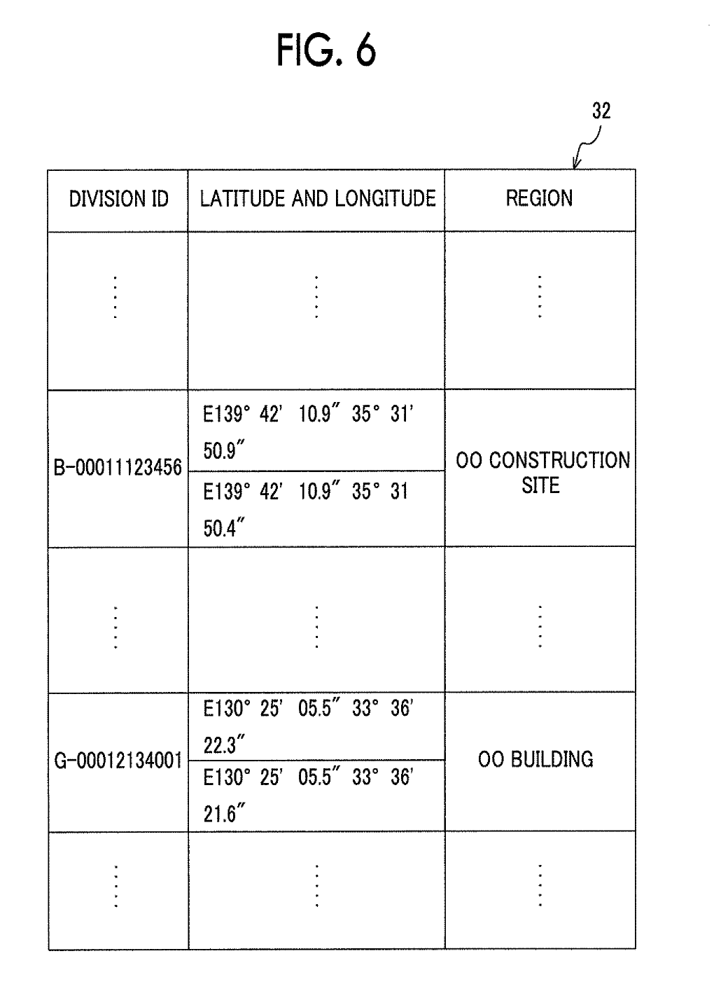

FIG. 6 shows an example of the region DB 32. The region DB 32 includes division IDs, latitude and longitude information and region information. The division IDs represent IDs that are respectively allocated to division regions obtained by dividing a map indicated by map information indicating the map of a predetermined region (for example, Japanese land territory) in a mesh form. Latitude and longitude information for specifying each latitude and longitude of two diagonal points of the division region specified by each division ID is allocated to each division ID. Further, region information indicating the division region on the map (hereinafter, referred to as “division region”) specified by each division ID is allocated to each division ID. As an example of the region information, information indicating a place name, a building name or the like that is a representative of the division region specified by the division ID is used. Further, the region information is freely rewritten by receiving an operation input using the receiving unit 86, for example. In the example shown in FIG. 6, region information indicating a division region “OO construction site” is allocated to a division ID “B-00011123456” by the operation input received by the receiving unit 86. Further, region information indicating a division region “OO building” is allocated to a division ID “G-00012134001”. Accordingly, in the server apparatus 14, if GPS information is input, a division region that includes a position specified by the input GPS information is specified. That is, the division ID and region information are uniquely specified on the basis of the input GPS information. Hereinafter, in order to prevent confusion, it is assumed that the region information is necessarily allocated to each division ID in the region DB 32, but in a case where the region information is not allocated, it is sufficient if the division ID is employed as the region information.

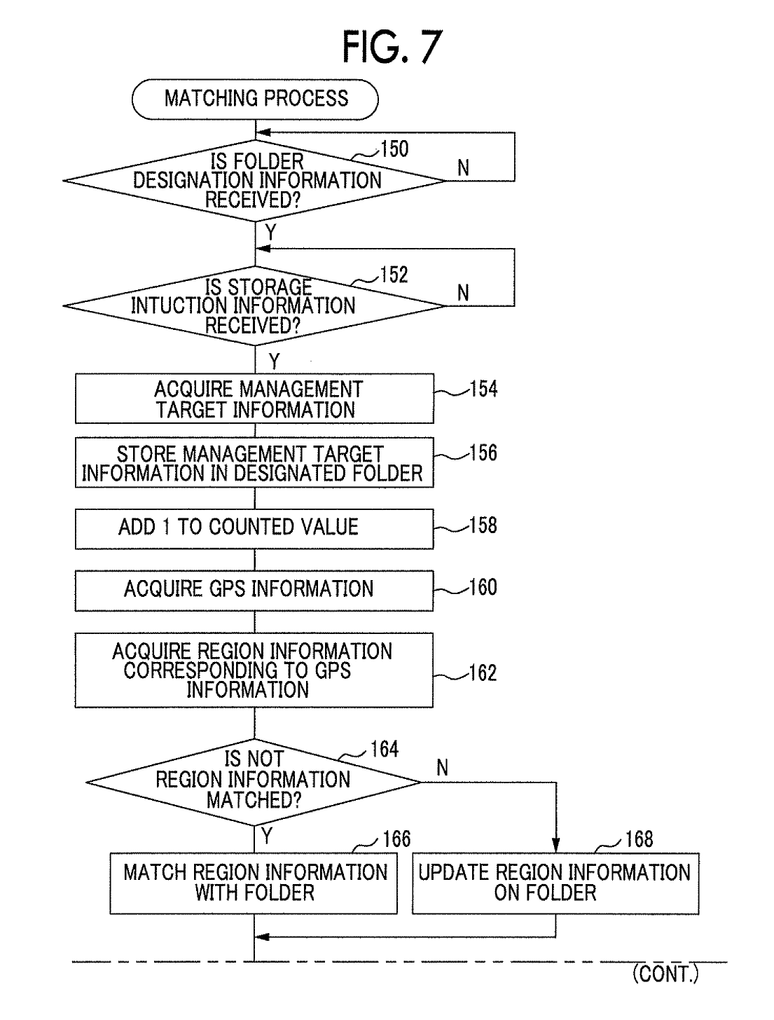

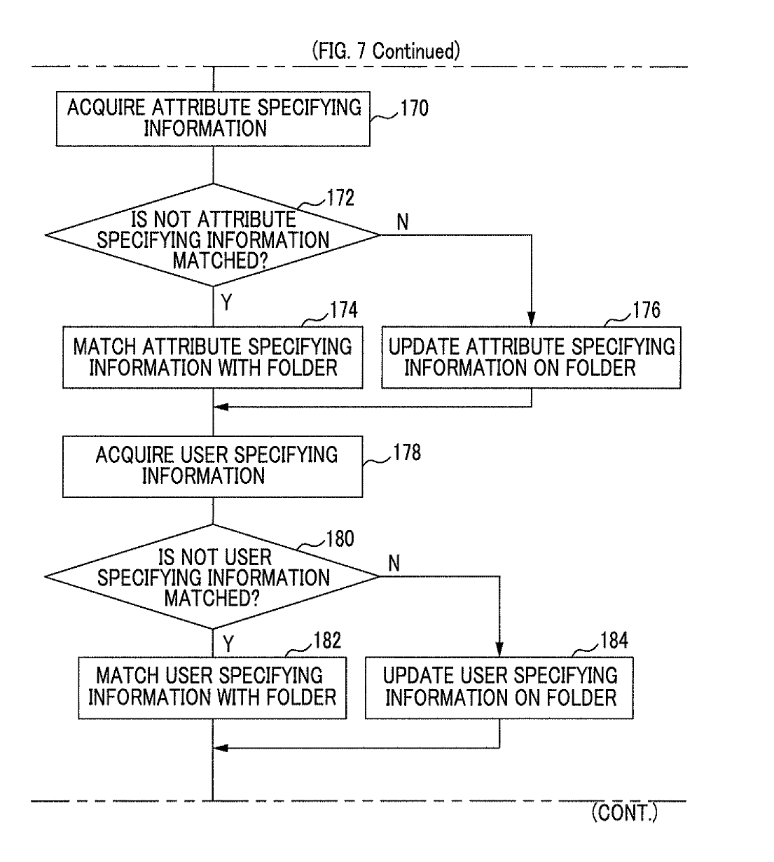

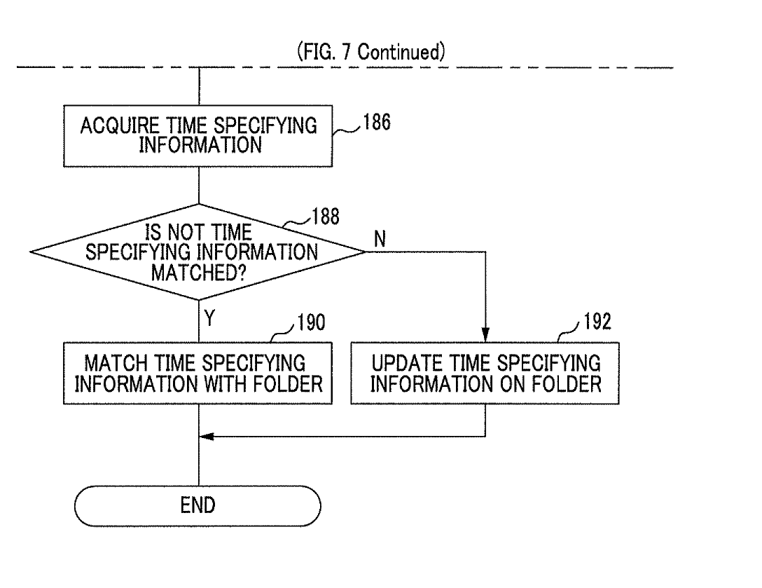

Next, as an operation of the present exemplary embodiment, a matching process that is performed by the server apparatus 14 by executing the matching process program 62 by the CPU 52 will be described with reference to FIG. 7. In the matching process shown in FIG. 7, firstly, in step 150, it is determined by the controller 16 whether folder designation information is received. In the present exemplary embodiment, the folder designation information is transmitted to the server apparatus 14 from the mobile terminal 12, as an example. Thus, in the present step 150, in a case where the folder designation information transmitted from the mobile terminal 12 is received by the controller 16, the determination is affirmative and thus proceeds to step 152. In the present step 150, in a case where the folder designation information transmitted from the mobile terminal 12 is not received by the controller 16, the determination is negative and thus performs the determination of the present step 150 again.

In step 152, it is determined by the controller 16 whether storage designation information indicating an instruction for storage of the management target information 22 in the folder 64 is received. In the present exemplary embodiment, as an example, the storage instruction information is transmitted to the server apparatus 14 from the mobile terminal 12. Further, the “storage instruction information” includes the management target information 22 stored in the folder 64 designated by the folder designation information received in step 150. Further, the “storage instruction information” includes GPS information. The employed GPS information represents GPS information that is recently acquired at the time when the instruction for storage of the management target information 22 in the folder 64 is given. Further, the “storage instruction information” includes user specifying information for specifying a user who gives the instruction for storage of the management target information 22 in the folder 64, that is, a user who gives an instruction of transmission of the storage instruction information to the server apparatus 14. Further, the “storage instruction information” includes attribute specifying information for specifying an attribute given to the user who gives the instruction of transmission of the storage instruction information to the server apparatus 14 (here, for example, gender information and user type information). Further, the “storage instruction information” includes time specifying information for specifying the time when the instruction for storage of the management target information 22 to the folder 64 is given, that is, the time (here, for example, date) when the instruction of transmission of the storage instruction information to the server apparatus 14 is given. In the present step 152, in a case where the storage instruction information is received by the receiving unit 18, the determination is affirmative and thus proceeds to step 154. In the present step 152, in a case where the storage instruction information is not received by the receiving unit 18, the determination is negative and thus performs the determination of the present step 152 again.

In step 154, the management target information 22 is acquired from the storage instruction information received in step 152, by the controller 16. In the next step 156, the management target information 22 acquired in step 154 is stored in the folder 64 designated by folder designation information received in step 150, by the controller 16. In the next step 158, 1 is added to a counted value matched with the folder ID of the folder 64 designated by the folder designation information received in step 150. Accordingly, the number of storages of the management target information 22 in the folder 64 is specified from the counted value.

In the next step 160, the GPS information is acquired from the storage instruction information received in step 152, by the controller 16. In the next step 162, region information corresponding to a division region that includes a position specified by the GPS information acquired in step 160 is acquired from the region DB 32, by the controller 16. In the next step 164, it is determined whether the region information is not matched with the folder ID of the folder 64 designated by the folder designation information received in step 150, by the controller 16. In the present step 164, in a case where the region information is not matched with the folder ID, the determination is affirmative and thus proceeds to step 166. In the present step 164, in a case where the region information is matched with the folder ID, the determination is negative and thus proceeds to step 168.

In step 166, the folder ID of the folder 64 designated by the folder designation information received in step 150 and the region information acquired in step 162 are matched with each other, by the controller 16.

In step 168, updating is performed by replacing the region information that is already matched with the folder ID of the folder 64 designated by the folder designation information received in step 150 with the region information acquired in step 162, by the controller 16.

In the next step 170, attribute specifying information is acquired from the storage instruction information received in step 152, by the controller 16. In the next step 172, it is determined by the controller 16 whether the attribute specifying information is not matched with the folder ID of the folder 64 designated by the folder designation information received in step 150. In the present step 172, in a case where the attribute specifying information is not matched with the folder ID, the determination is affirmative and thus proceeds to step 174. In the present step 172, in a case where the attribute specifying information is matched with the folder ID, the determination is negative and thus proceeds to step 176.

In step 174, the folder ID of the folder 64 designated by the folder designation information received in step 150 and the attribute specifying information acquired in step 170 are matched with each other, by the controller 16.

In step 176, updating is performed by replacing the attribute specifying information that is already matched with the folder ID of the folder 64 designated by the folder designation information received in step 150 with the attribute specifying information acquired in step 170, by the controller 16.

In the next step 178, user specifying information is acquired from the storage instruction information received in step 152, by the controller 16. In the next step 180, it is determined by the controller 16 whether the user specifying information is not matched with the folder ID of the folder 64 designated by the folder designation information received in step 150. In the present step 180, in a case where the user specifying information is not matched with the folder ID, the determination is affirmative and thus proceeds to step 182. In the present step 180, in a case where the user specifying information is matched with the folder ID, the determination is negative and thus proceeds to step 184.

In step 182, the folder ID of the folder 64 designated by the folder designation information received in step 150 and the user specifying information acquired in step 178 are matched with each other, by the controller 16.

In step 184, updating is performed by replacing the user specifying information that is already matched with the folder ID of the folder 64 designated by the folder designation information received in step 150 with the user specifying information acquired in step 178, by the controller 16.

In the next step 186, time specifying information is acquired from the storage instruction information received in step 152, by the controller 16. In the next step 188, it is determined by the controller 16 whether the time specifying information is not matched with the folder ID of the folder 64 designated by the folder designation information received in step 150. In the present step 188, in a case where the time specifying information is not matched with the folder ID, the determination is affirmative and thus proceeds to step 190. In the present step 188, in a case where the time specifying information is matched with the folder ID, the determination is negative and thus proceeds to step 192.

In step 190, the folder ID of the folder 64 designated by the folder designation information received in step 150 and the time specifying information acquired in step 186 are matched with each other, by the controller 16.

In step 192, updating is performed by replacing the time specifying information that is already matched with the folder ID of the folder 64 designated by the folder designation information received in step 150 with the time specifying information acquired in step 186, by the controller 16. Further, as processes of steps 190 and 192 are performed, the time specifying information matched with the folder ID is used as the storage time information in the attribute DB 30 and the user DE 28.

In this way, by performing the matching process, the region information, the attribute specifying information, the user specifying information and the time specifying information are matched with the folder ID, to thereby form the attribute DB 30 shown in FIG. 4 and the user DB 28 shown in FIG. 5.

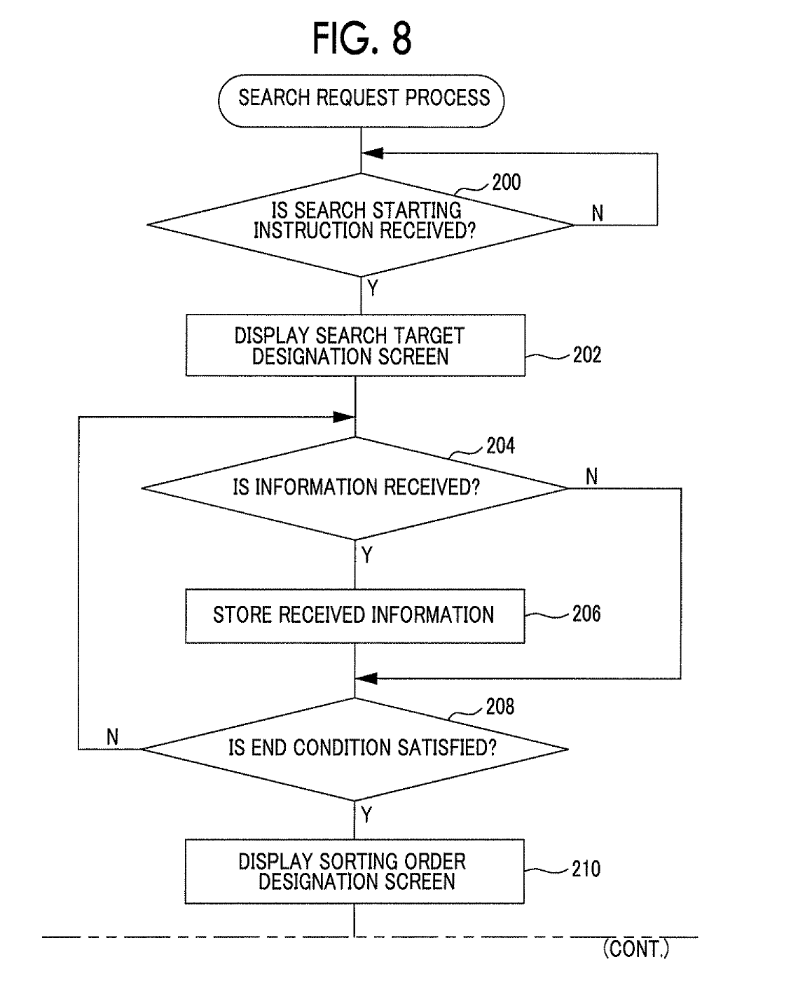

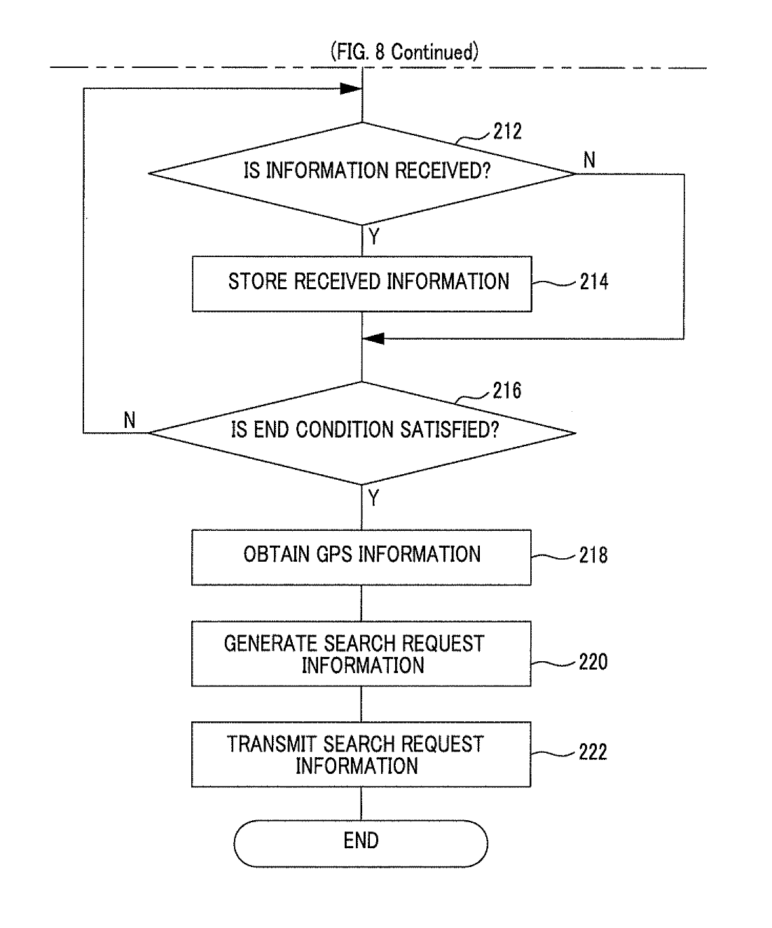

As an operation of the present exemplary embodiment, a search request process performed by the mobile terminal 12 by executing a search request process program by the CPU 100A will be described with reference to FIG. 8. In the search request process shown in FIG. 8, firstly, in step 200, it is determined by the CPU 100A whether a search start instruction for instructing the starting of search of the folder 64 stored in the storage unit 56 of the server apparatus 14 is received by the receiving unit 106. In the present step 200, in a case where the search start instruction is received by the receiving unit 106, the determination is affirmative and thus proceeds to step 202. In the present step 200, in a case where the search start instruction is not received by the receiving unit 106, the determination is negative to thus perform the determination of the present step 200 again.

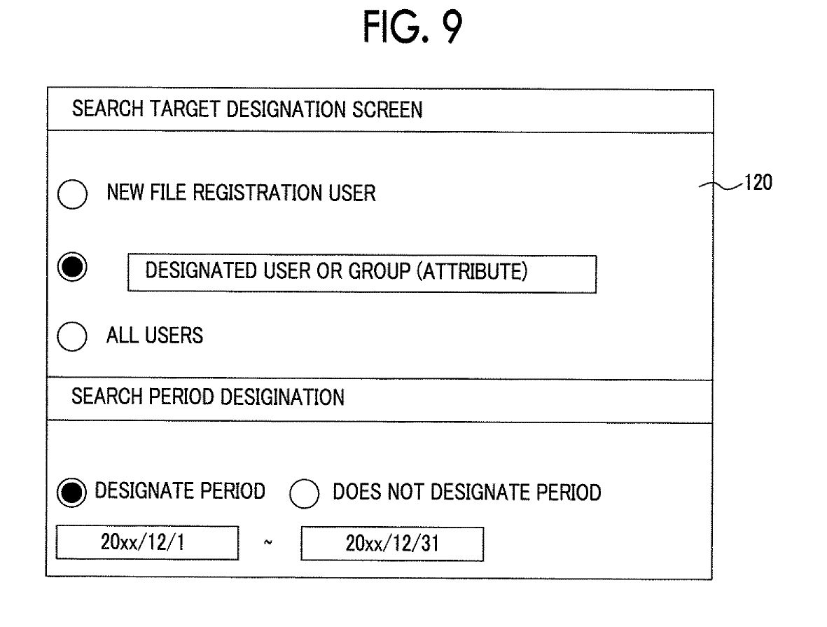

In step 202, a search target designation screen 120 shown in FIG. 9 is displayed on the display 108 by the CPU 100A as an example. The search target designation screen 120 is divided into an upper screen and a lower screen as shown in FIG. 9. The upper screen is a user interface screen on which information for designating information (here, gender information and user type information) indicating user name information of the user DB 28 and information indicating an attribute given to the user is received as a search target. An item of “new file user registration” is formed on the upper screen. The item of “new file user registration” represents an item for comprehensively designating the user who relatively recently stores the management target information 22 in the folder 64. All the users who store the management target information 22 in the folder 64 from a time point prior to a current time point by a predetermined period of time to the current time are designated. Further, an input section item for inputting a user name or attribute that specifies a user who is individually and specifically designated is formed on the upper screen. Further, an item of “all users” in which all the users are search targets is formed on the upper screen. Further, a radio button is correspondingly formed in each item, and as an instruction for selecting a certain radio button is received by the receiving unit 106, the radio button is selected according to the instruction. In a default setting, the of “all users” is selected.

The lower screen of the search target designation screen 120 is a user interface screen on which information for designating the period when the management target information 22 is stored in the folder 64 is received as a search target. An item of “period designation” indicating that the period is designated and an item of “period non-designation” indicating that the period is not designated are formed on the lower screen. Further, a radio button is correspondingly formed in each item, and as an instruction for selecting a certain radio button is received by the receiving unit 106, the radio button is selected according to the instruction. Further, in a case where the item of “period designation” is selected, as a period input section for inputting the period, a start time input section in which a start time of the period is input and an end time input section in which an end time of the period is input are formed. In an example shown in FIG. 9, as the period when the management target information 22 is stored in the folder 64, a period from Dec. 1, 20xx to Dec. 31, 20xx is designated. In a default setting, the item of “period non-designation” is selected. In this case, input to the period input section is not allowed.

In the next step 204, it is determined by the CPU 100A whether information corresponding to the item displayed on the search target designation screen 120 is received by the receiving unit 106. In the present step 204, in a case where the information corresponding to the item displayed on the search target designation screen 120 is received by the receiving unit 106, the determination is affirmative and thus proceeds to step 206. In the present step 204, in a case where the information corresponding to the item displayed on the search target designation screen 120 is not received by the receiving unit 106, the determination is negative and thus proceeds to step 208.

In step 206, the information received by the receiving unit 106 is stored in a predetermined storage area in the RAM 100C, by the CPU 100A. In step 208, it is determined by the CPU 100A whether the condition (for example, condition that a predetermined time elapses after the search target designation screen 120 is displayed) under which the designation of the search target ends is satisfied. In the present step 208, in a case where the condition under which the designation of the search target ends is satisfied, the determination is affirmative and thus proceeds to step 210. In the present step 208, in a case where the condition under which the designation of the search target ends is not satisfied, the determination is negative and thus returns to step 204.

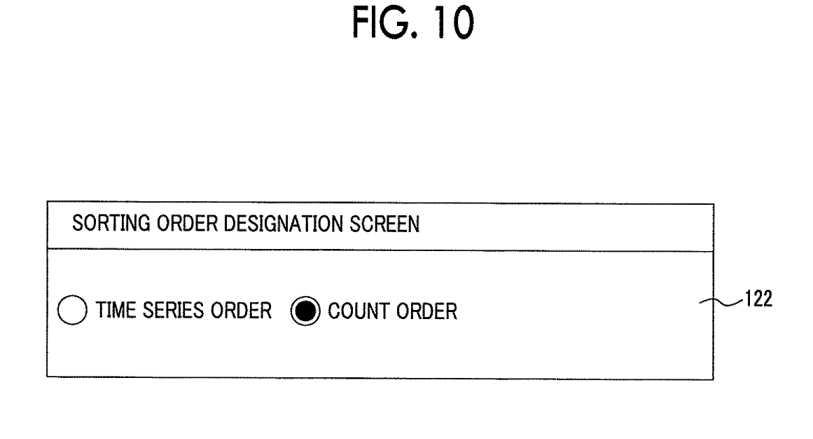

In step 210, for example, a sorting order designation screen 122 shown in FIG. 10 is displayed on the display 108 by the CPU 100A. The sorting order designation screen 122 is a user interface screen for designating the sorting order of the folders 64 displayed on the display 108 as a search result of the folder 64 in a predetermined direction (for example, from the top to the bottom of the screen). An item of “time series order” in which the folders are sorted in a predetermined direction in a time series order of the storage period and an item of “count order” in which the folders are stored in a predetermined direction in the order of counted storages are formed on the sorting order designation screen 122. Further, a radio button is correspondingly formed in each item, and as an instruction for selecting a certain radio button is received by the receiving unit 106, the radio button is selected according to the instruction. In a default setting, the item of “count order” is selected.

In the next step 212, it is determined by the CPU 100A whether information corresponding to the item displayed on the sorting order designation screen 122 is received by the receiving unit 106. In the present step 212, in a case where the information corresponding to the item displayed on the sorting order designation screen 122 is received by the receiving unit 106, the determination is affirmative and thus proceeds to step 214. In the present step 212, in a case where the information corresponding to the item displayed on the sorting order designation screen 122 is not received by the receiving unit 106, the determination is negative and thus proceeds to step 216.

In step 214, the information received by the receiving unit 106 is stored in a storage area that is determined in advance in the RAM 100C, by the CPU 100A. In step 216, it is determined by the CPU 100A whether the condition (for example, condition that a predetermined time elapses after the sorting order designation screen 122 is displayed) under which the designation of the sorting order ends is satisfied. In the present step 216, in a case where the condition under which the designation of the sorting order ends is satisfied, the determination is affirmative and thus proceeds to step 218. In the present step 216, in a case where the condition under which the designation of the sorting order ends is not satisfied, the determination is negative to thus return to step 212.

In step 218, the GPS information is acquired by the acquisition unit 16. In the next step 220, search request information is generated on the basis of the information stored in the storage area predetermined in the RAM 100C in steps 206 and 214 and the GPS information acquired in step 212, by the CPU 100A. Further, in the next step 222, the search request information is transmitted to the server apparatus 14 by the mobile terminal 12, and then the search request process ends. Here, the “search request information” represents information for requesting the server apparatus 14 to search the folder 64. The search request information includes the GPS information acquired in step 212. Further, the search request information includes information corresponding to the information stored in the storage area predetermined in the RAM 100C in steps 206 and 214. For example, as the information corresponding to the information stored in the storage area predetermined in the RAM 100C in step 206, user specifying information, attribute specifying information and period specifying information are used. Further, as the information corresponding to the information stored in the storage area predetermined in the RAM 100C in step 214, sorting order information indicating whether the item of “time series order” is selected or the item of “count order” is selected is used.

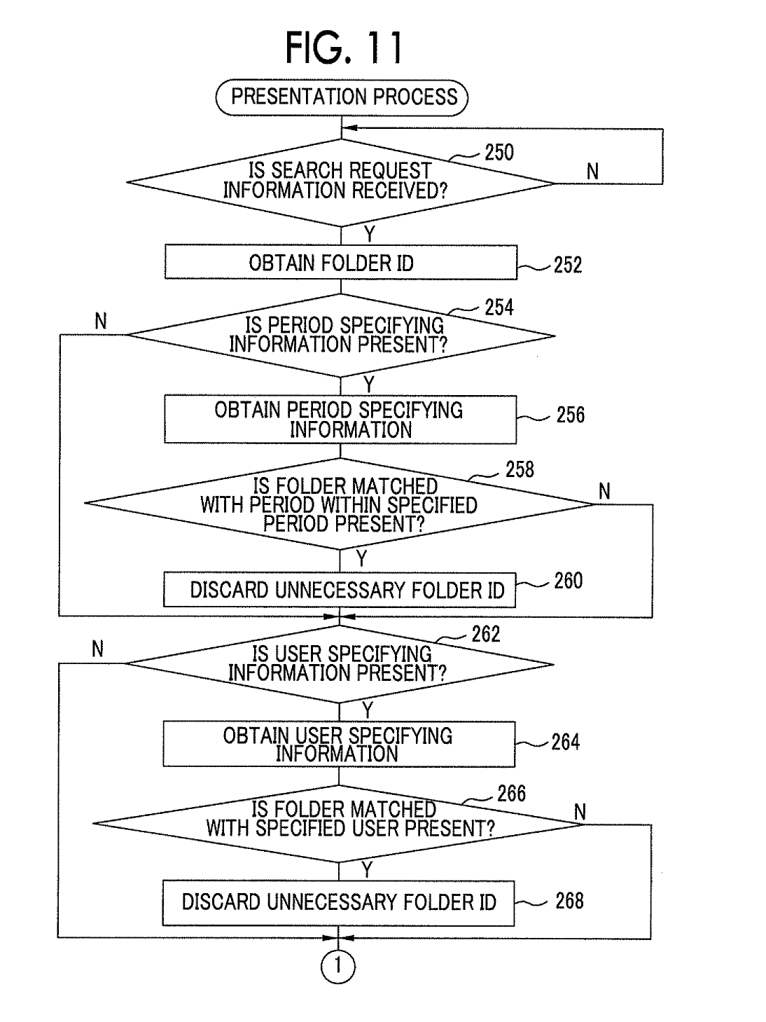

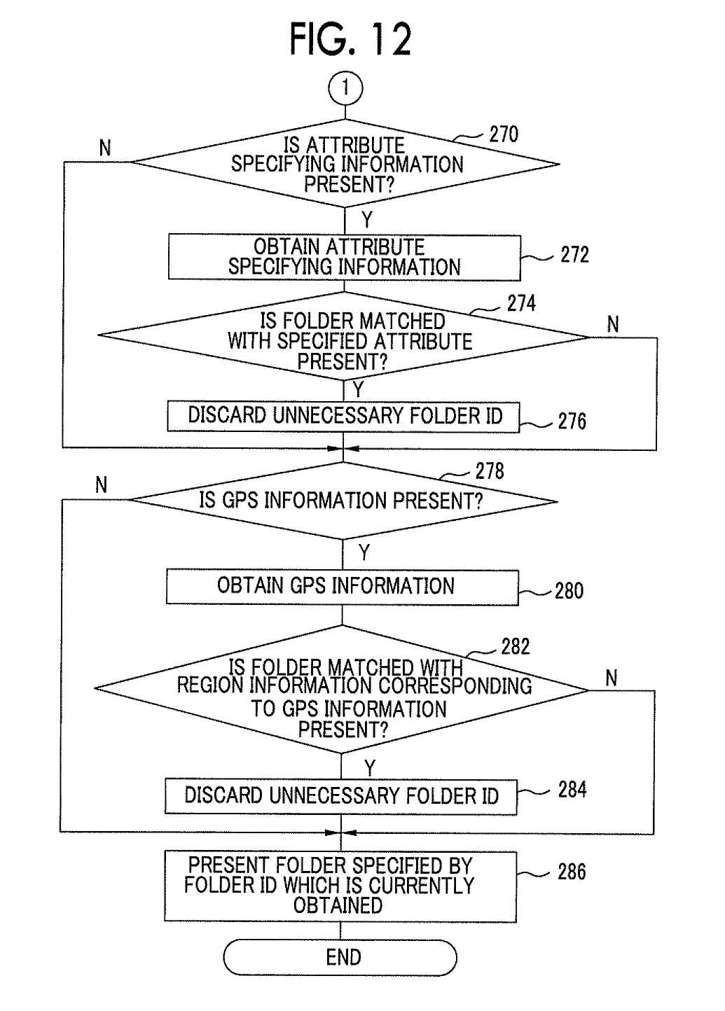

Next, as an operation of the present exemplary embodiment, a presentation process performed by the server apparatus 14 as the CPU 52 executes the presentation process program 60 will be described with reference to FIG. 11. In the presentation process shown in FIG. 11, firstly, in step 250, it is determined by the presentation unit 20 whether the search request information transmitted in step 222 is received. In the present step 250, in a case where the search request information is received, the determination is affirmative and thus proceeds to step 252. In the present step 250, in a case where the search request information is not received, the determination is negative to thus perform the determination of step 250 again.

In step 252, the folder IDs stored in the storage unit 56 are all acquired by the presentation unit 20. In the next step 254, it is determined by the receiving unit 18 whether period specifying information is included in the search request information received in step 250. In the present step 254, in a case where the period specifying information is included in the search request information, the determination is affirmative and thus proceeds to step 256. In the present step 254, in a case where the period specifying information is not included in the search request information, the determination is negative and thus proceeds to step 262.

In step 256, the period specifying information is acquired from the search request information received in step 250 by the receiving unit 18. In the next step 258, it is determined by the presentation unit 20 whether a folder ID matched with storage time information corresponding to the period specifying information acquired in step 256 is present in the folder IDs acquired in step 252. That is, it is determined by the presentation unit 20 whether the folder ID matched with the storage time information indicating the storage time included in a period of time specified by the period specifying information acquired in step 256 is present in the folder IDs acquired in step 252. In the present step 258, in a case where the folder ID matched with the storage time information indicating the storage time included in the period of time specified by the period specifying information acquired in step 256 is present, the determination is affirmative and thus proceeds to step 260. In the present step 258, in a case where the folder ID matched with the storage time information indicating the storage time included in the period of time specified by the period specifying information acquired in step 256 is not present, the determination is negative and thus proceeds to step 262.

In step 260, an unnecessary folder ID among the folder IDs acquired in step 252 is discarded by the presentation unit 20. That is, the folder ID that is not matched with the storage time information indicating the storage time included in the period of time specified by the period specifying information acquired in step 256 is discarded.

In the next step 262, it is determined by the receiving unit 18 whether user specifying information is included in the search request information received in step 250. In the next step 262, in a case where the user specifying information is included in the search request information, the determination is affirmative and thus proceeds to step 264. In the present step 262, in a case where the user specifying information is not included in the search request information, the determination is negative and thus proceeds to step 270.

In step 264, the user specifying information is acquired from the search request information received in step 250 by the receiving unit 18. In the next step 266, it is determined by the presentation unit 20 whether a folder ID matched with a user specified by the user specifying information acquired in step 264 is present in the remaining folder IDs after the unnecessary ID is discarded in step 260. That is, it is determined by the presentation unit 20 whether a folder ID matched with user name information corresponding to the user specifying information acquired in step 256 is present in the remaining folder IDs after the unnecessary folder ID is discarded in step 260. In the present step 266, in a case where the folder ID matched with the user specified by the user specifying information acquired in step 264 is present, the determination is affirmative and thus proceeds to step 268. In the present step 266, in a case where the folder ID matched with the user specified by the user specifying information acquired in step 264 is not present, the determination is negative and thus proceeds to step 270.

In step 268, an unnecessary folder ID is again discarded from the remaining folder IDs after the unnecessary folder ID is discarded in step 260 from the folder IDs acquired in step 252, by the presentation unit 20. That is, the folder ID that is not matched with the user specified by the user specifying information acquired in step 264 is discarded.

In the next step 270, it is determined by the receiving unit 18 whether attribute specifying information is included in the search request information received in step 250. In the present step 270, in a case where the attribute specifying information is included in the search request information, the determination is affirmative and thus proceeds to step 272. In the present step 270, in a case where the attribute specifying information is not included in the search request information, the determination is negative and thus proceeds to step 278.

In step 272, the attribute specifying information is acquired from the search request information received in step 250 by the receiving unit 18. In the next step 274, it is determined by the presentation unit 20 whether a folder ID matched with an attribute specified by the attribute specifying information acquired in step 272 is present in the remaining folder IDs after the unnecessary folder ID is discarded in step 268. That is, it is determined whether a folder ID matched with at least one of gender information and user type information corresponding to the attribute specifying information acquired in step 272 is present in the remaining folder IDs after the unnecessary folder ID is discarded in step 268. In the present step 274, in a case where the folder ID matched with the attribute specified by the attribute specifying information acquired in step 272 is present, the determination is affirmative and thus proceeds to step 276. In the present step 274, in a case where the folder ID matched with the attribute specified by the attribute specifying information acquired in step 272 is not present, the determination is negative and thus proceeds to step 278.

In step 276, an unnecessary folder ID is again discarded from the remaining folder IDs after the unnecessary folder ID is discarded in step 268, by the presentation unit 20. That is, the folder ID that is not matched with the attribute specified by the attribute specifying information acquired in step 272 is discarded.

In the next step 278, it is determined by the receiving unit 18 whether GPS information is included in the search request information received in step 250. In the present step 278, in a case where the GPS information is included in the search request information, the determination is affirmative and thus proceeds to step 280. In the present step 278, in a case where the GPS information is not included in the search request information, the determination is negative and thus proceeds to step 286.

In step 280, the GPS information is acquired from the search request information received in step 250 by the receiving unit 18. In the next step 282, it is determined by the presentation unit 20 whether a folder ID matched with a place specified by the GPS information acquired in step 280 is present in the remaining folder IDs after the unnecessary folder ID is discarded in step 276. That is, it is determined whether a folder ID matched with region information indicating a place that includes a position specified by the GPS information acquired in step 280 is present in the remaining folder IDs after the unnecessary folder ID is discarded in step 276. In the present step 282, in a case where the folder ID matched with the place corresponding to the GPS information acquired in step 280 is present, the determination is affirmative and thus proceeds to step 284. In the present step 282, in a case where the folder ID matched with the place corresponding to the GPS information acquired in step 280 is not present, the determination is negative and thus proceeds to step 286.

In step 284, an unnecessary folder ID is again discarded from the remaining folder IDs after the unnecessary folder ID is discarded in step 276, by the presentation unit 20. That is, the folder ID that is not matched with the place corresponding to the GPS information acquired in step 280 is discarded.

In the next step 286, the folder 64 specified by the folder ID as the folder ID that is acquired at a current time point is transmitted to the mobile terminal 12 is presented to a user by the presentation unit 20, and then, the present presentation process ends. That is, if step 286 is performed, the mobile terminal 12 receives the folder ID, and then accesses the folder 64 corresponding to the server apparatus 14 using the received folder ID. Further, folder information indicating the previously accessed folder 64 is provided to the mobile terminal 12. If the folder information is provided to the mobile terminal 12, the mobile terminal 12 displays the folder 64 indicated by the folder information supplied from the server apparatus 14 on the display 108 to present the folder 64 to the user.

In step 286, the folder ID may be transmitted to the mobile terminal 12 by the presentation unit 20 in a state where the sorting order information included in the search request information received in step 250 is given. Thus, in the mobile terminal 12, the folder 64 presented on the basis of the folder ID from the server apparatus 14 is displayed in the sorting order indicated by the sorting order information in a predetermined direction on the screen.

In the above-described exemplary embodiment, as in step 286, an aspect that the folder 64 specified by the folder ID is presented to the mobile terminal 12 as the folder ID is transmitted to the mobile terminal 12 is shown, but the disclosure is not necessarily limited thereto. For example, the folder 64 specified by the folder ID may be displayed on the display 88 to be presented to a user.

Further, in the above-described exemplary embodiment, an aspect of the case where the server apparatus 14 receives the search request information including the GPS information in a wireless communication to receive the GPS information by the computer 50 is shown, but the disclosure is not limited thereto. For example, an operation input may be performed with respect to the receiving unit 86 to receive the GPS information by the receiving unit 86, and then, the GPS information received by the receiving unit 86 may be received by the computer 50.

Further, in the above-described exemplary embodiment, the search request process is performed by the mobile terminal 12 and the matching process and the presentation process are performed by the server apparatus 14, but the disclosure is not limited thereto. For example, a process corresponding to the matching process, a process corresponding to the search request process and a process corresponding to the presentation process may be performed by a portable or installed personal computer mounted with a GPS function. In this case, the personal computer includes the controller 16, the receiving unit 18, the presentation unit 20 and the storage unit 26. Further, in this case, processes instead of reception of the folder designation information in step 150, reception of the storage instruction information in step 152, transmission of the search request information in step 222 and reception of the search request information in step 250 are necessary. That is, instead of reception of the folder designation information in step 150, a process of receiving designation of the folder 64 is necessary. Further, instead of reception of the storage instruction information in step 152, a process of receiving an instruction for storage of the management target information 22 in the folder 64 is necessary. Further, instead of transmission of the search request information in step 222 and reception of the search request information in step 250, reception of a search request is necessary. For example, reception of designation of the folder 64, reception of the instruction for storage of the management target information 22 in the folder 64 and reception of the search request may be performed by an operation input with respect to an input device connected to a personal computer, or may be performed a remote operation using wireless communication.

Further, in the above-described exemplary embodiment, an aspect that the region information is specified from the GPS information and the folder ID is specified from the specified region information is shown, but the disclosure is not limited thereto. For example, place name information indicating a formal name or a popular name of a place may be received by the receiving unit 18, and then, the folder 64 may be specified from a folder ID matched with region information corresponding to the received place name information. Further, a division ID in addition to the region information may be matched in advance with the folder ID, and then, the division ID may be received by the receiving unit 18 and the folder ID matched with the received division ID may be specified. Alternatively, the division ID instead of the region information may be matched in advance with the folder ID, and then, the division ID may be received by the receiving unit 18 and the folder ID matched with the received division ID may be specified. Further, latitude and longitude information may be matched with the folder ID, and then, the GPS information or the latitude and longitude information may be received by the receiving unit 18 and the folder 64 may be specified from the folder ID matched with the latitude and longitude information corresponding to the received GPS information or latitude and longitude information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a controller that performs a control for storing, in a case where an instruction for storage of management target information is performed, the management target information and for matching, for storage in a storage area, region information indicating a predetermined range of regions that includes a place where the instruction is performed with storage location information indicating a storage location where the management target information is stored;
a receiving unit that receives specified place information indicating a specified place; and
a presentation unit that presents, in a case where region information corresponding to the specified place information received by the receiving unit is stored in the storage area, the storage location information matched with the region information corresponding to the specified place information.

2. The information processing apparatus according to claim 1,
wherein the receiving unit further receives the instruction for storage, the region information and the management target information, and
wherein the controller performs the control on the basis of the reception result of the receiving unit.

3. The information processing apparatus according to claim 1,
wherein the receiving unit receives the specified place information by receiving the specified place information transmitted from a mobile terminal in the place where the instruction for storage is performed.

4. The information processing apparatus according to claim 2,
wherein the receiving unit receives the specified place information by receiving the specified place information transmitted from a mobile terminal in the place where the instruction for storage is performed.

5. The information processing apparatus according to claim 1,
wherein in a case where the instruction for storage is performed, the controller further performs again a control for matching, for storage in the storage area, the region information indicating the predetermined range of region that includes the place where the instruction is performed with the storage location information indicating the storage location where the management target information is stored, according to the instruction.

6. The information processing apparatus according to claim 2,
wherein in a case where the instruction for storage is performed, the controller further performs again a control for matching, for storage in the storage area, the region information indicating the predetermined range of region that includes the place where the instruction is performed with the storage location information indicating the storage location where the management target information is stored, according to the instruction.

7. The information processing apparatus according to claim 3,
wherein in a case where the instruction for storage is performed, the controller further performs again a control for matching, for storage in the storage area, the region information indicating the predetermined range of region that includes the place where the instruction is performed with the storage location information indicating the storage location where the management target information is stored, according to the instruction.

8. The information processing apparatus according to claim 4,
wherein in a case where the instruction for storage is performed, the controller further performs again a control for matching, for storage in the storage area, the region information indicating the predetermined range of region that includes the place where the instruction is performed with the storage location information indicating the storage location where the management target information is stored, according to the instruction.

9. The information processing apparatus according to claim 1,
wherein in a case where the instruction for storage is performed, the controller further performs a control for replacing the region information indicating the predetermined range of regions that includes the place where the instruction is performed with the region information that is currently matched with the storage location information indicating the storage location where the management target information is stored, according to the instruction, for storage in the storage area.

10. The information processing apparatus according to claim 2,
wherein in a case where the instruction for storage is performed, the controller further performs a control for replacing the region information indicating the predetermined range of regions that includes the place where the instruction is performed with the region information that is currently matched with the storage location information indicating the storage location where the management target information is stored, according to the instruction, for storage in the storage area.

11. The information processing apparatus according to claim 3,
wherein in a case where the instruction for storage is performed, the controller further performs a control for replacing the region information indicating the predetermined range of regions that includes the place where the instruction is performed with the region information that is currently matched with the storage location information indicating the storage location where the management target information is stored according to the instruction, for storage in the storage area.

12. The information processing apparatus according to claim 4,
wherein in a case where the instruction for storage is performed, the controller further performs a control for replacing the region information indicating the predetermined range of regions that includes the place where the instruction is performed with the region information that is currently matched with the storage location information indicating the storage location where the management target information is stored, according to the instruction, for storage in the storage area.

13. The information processing apparatus according to claim 1,
wherein a user that performs the instruction is matched with the storage location information indicating the storage location where the management target information is stored according to the instruction for storage,
wherein the receiving unit further receives user specifying information for specifying the user, and
wherein in a case where the region information corresponding to the specified place information received by the receiving unit is stored in the storage area, the presentation unit presents the storage location information matched with the region information corresponding to the specified place information, using the storage location information matched with the user specified by the user specifying information received by the receiving unit as a presentation target candidate.

14. The information processing apparatus according to claim 2,
wherein a user that performs the instruction is matched with the storage location information indicating the storage location where the management target information is stored according to the instruction for storage,
wherein the receiving unit further receives user specifying information for specifying the user, and
wherein in a case where the region information corresponding to the specified place information received by the receiving unit is stored in the storage area, the presentation unit presents the storage location information matched with the region information corresponding to the specified place information, using the storage location information matched with the user specified by the user specifying information received by the receiving unit as a presentation target candidate.

15. The information processing apparatus according to claim 1,
wherein an attribute assigned to a user that performs the instruction is matched with the storage location information indicating the storage location where the management target information is stored according to the instruction for storage,
wherein the receiving unit further receives attribute specifying information for specifying the attribute, and
wherein in a case where the region information corresponding to the specified place information received by the receiving unit is stored in the storage area, the presentation unit presents the storage location information matched with the region information corresponding to the specified place information, using the storage location information matched with the attribute specified by the attribute specifying information received by the receiving unit as a presentation target candidate.

16. The information processing apparatus according to claim 1,
wherein the time when the instruction is performed is matched with the storage location information indicating the storage location where the management target information is stored according to the instruction for storage,
wherein the receiving unit further receives period specifying information for specifying a period during which the management target information is stored in the storage location, and
wherein in a case where the region information corresponding to the specified place information received by the receiving unit is stored in the storage area, the presentation unit presents the storage location information matched with the region information corresponding to the specified place information, using the storage location information matched with time included in the period specified by the period specifying information received by the receiving unit as a presentation target candidate.

17. The information processing apparatus according to claim 1,
wherein a user that performs the instruction, an attribute assigned to the user that performs the instruction and the time when the instruction is performed are matched with the storage location information indicating the storage location where the management target information is stored according to the instruction for storage,
wherein the receiving unit further receives user specifying information for specifying the user, attribute specifying information for specifying the attribute and period specifying information for specifying a period during which the management target information is stored in the storage location, and
wherein in a case where the region information corresponding to the specified place information received by the receiving unit is stored in the storage area, the presentation unit presents the storage location information matched with the region information corresponding to the specified place information, using the storage location information matched with at least one of the user specified by the user specifying information received by the receiving unit, the attribute specified by the attribute specifying information received by the receiving unit and the period specified by the period specifying information received by the receiving unit as a presentation target candidate.

18. A non-transitory computer readable medium that stores a program that causes a computer that controls an information processing apparatus including a controller that performs a control for storing, in a case where an instruction for storage of management target information is performed, the management target information and for matching, for storage in a storage area, region information indicating a predetermined range of region that includes a place where the instruction is performed with storage location information indicating a storage location where the management target information is stored, to function as:
a receiving unit that receives specified place information indicating a specified place; and
a presentation unit that presents, in a case where region information corresponding to the specified place information received by the receiving unit is stored in the storage area, the storage location information matched with the region information corresponding to the specified place information.

19. A non-transitory computer readable medium that stores a program that causes a computer to function as the controller, the receiving unit and the presentation unit included in the information processing apparatus according to claim 1.

20. An information processing method comprising:
performing a control for storing, in a case where an instruction for storage of management target information is performed, the management target information and for matching, for storage in a storage area, region information indicating a predetermined range of regions that includes a place where the instruction is performed with storage location information indicating a storage location where the management target information is stored;
receiving specified place information indicating a specified place; and
presenting, in a case where region information corresponding to the received specified place information is stored in the storage area, the storage location information matched with the region information corresponding to the specified place information.
